(19) United States
(12) Patent Application Publication
(10) Pub. No.: US 2015/0294605 A1
(43) Pub. Date: Oct. 15, 2015

(54) Truck Bed Stake Pocket Flag Pole Mount

(71) Applicant: Hugh G. Conway, Goreville, IL (US)

(72) Inventor: Hugh G. Conway, Goreville, IL (US)

(21) Appl. No.: 14/248,526

(22) Filed: Apr. 9, 2014

(51) Int. Cl. G09F 17/00

(52) U.S. Cl. CPC G09F 17/00; G09F 2017/0075

(57) ABSTRACT

A truck bed stake pocket flag pole mount having a base and a mount composed of a single molded or welded material. The base configured to engage with stake pocket of a truck. The mount having an elongated chamber configured to engage with and conform to a flag pole. The mount and the flag pole having aligned apertures for securing the flag pole to the mount by a lock pin mechanism. The lock pin mechanism having a lock pin and a tether. The base having a threaded aperture configured to engage an eyebolt for securing the base to a truck bed stake pocket, and the eyebolt having an eye for securing an extant rope to the flag pole.

### BACKGROUND OF THE INVENTION

Various types of truck bed stake pocket flag pole mounts are known in the prior art. However, the known truck bed stake pocket flag pole mounts require complex assembly of a daunting amount of components. A common problem is that many of these components will get lost over the life of the known flag pole mounts, rendering the device inoperable. Further, many of these mounts lack a means to reliably secure the flag pole mount to the truck bed stake, rendering them unsafe for transportation and allowing them to disengage from the truck bed stake pockets while the truck is in motion. Further, the prior art lacks flag pole mounts that are removable from a base, thus allowing for convenient set up and take down of a user's flag, while enabling the base to remain conveniently stored within the truck bed stake pocket. Even further, other flag mounts take up space within the bed of the truck, rendering the flag pole mount inconvenient for transporting goods within the truck bed while flying the flag.

Thus, what is needed is a truck bed stake pocket flag pole mount having a base and a mount composed of a single molded or welded material. The mount having an elongated chamber configured to engage and conform to a flag pole. The mount and the flag pole having aligned apertures for securing the flag pole to the mount by a lock pin mechanism. The base having a threaded aperture configured to engage an eyebolt for securing the base to a truck bed stake pocket, and the eyebolt having an eye for securing an extant rope to the flag pole. Thus, the improved truck bed stake pocket flag pole mount allows for convenient assembly and storage of the mount, while providing multiple safety mechanisms to prevent the flag pole mount from becoming unintentionally disengaged from the stake pocket of a truck bed.

### FIELD OF THE INVENTION

The present invention relates to a truck bed stake pocket flag pole mount, and more particularly, to a truck bed stake pocket flag pole mount having a design that enables inexpensive manufacture and easy, convenient use. The present truck bed stake pocket flag pole mount has a base and a mount composed of a single molded or welded material. The mount having an elongated chamber configured to engage and conform to a flag pole. The mount and the flag pole having aligned apertures for securing the flag pole to the mount by a lock pin mechanism. The base having a threaded aperture configured to engage an eyebolt for securing the base to a truck bed stake pocket, and the eyebolt having an eye for securing an extant rope to the flag pole.

### SUMMARY OF THE INVENTION

The general purpose of the present truck bed stake pocket flag pole mount, described subsequently in greater detail, is to provide a truck bed stake pocket flag pole mount which has many novel features that result in a truck bed stake pocket flag pole mount which is not anticipated, rendered obvious, suggested, or even implied by prior art, either alone or in combination thereof.

The truck bed stake pocket flag pole mount includes a parallelepiped base having a first surface spaced apart from a parallel second surface, and four spaced apart side surfaces perpendicular to each of the first surface and second surface. Each of the first surface and second surface have a pair of spaced apart parallel first edges and a pair of spaced apart parallel second edges, respectively. Each of the second edges are perpendicular to each of the first edges. The first edges each have a length, while each of the second edges have a width. Each of the side surfaces define a total of four side edges having a height.

A cylindrical mount is medially disposed upon the first surface. The mount has an elongated chamber having a chamber diameter and a chamber length. The truck bed stake pocket flag pole mount also includes a flag pole having a flag pole hole. The flag pole is configured to engage the elongated chamber of the mount. The elongated chamber is configured to conform to the flag pole and support the flag pole in a vertical or angular position. A person having skill in the art would appreciate that the mount can be vertically disposed upon the first surface, and alternately can be disposed upon the first surface at an angle.

A threaded aperture is disposed upon one of the side surfaces of the base. A threaded eyebolt having an eye is configured to frictionally engage the threaded aperture through an extant eyelet of an extant truck bed. The eyebolt is configured to secure the base to an extant truck bed stake pocket. The eyebolt is also configured to secure an extant rope to the flag pole serving as a safety to prevent the flag pole from disengaging the elongated chamber.

A first lock pin hole and a second lock pin hole are diametrically disposed upon the mount. The truck bed stake pocket flag pole mount also includes a lock pin having a first end and a second end. A head is disposed upon the first end, and a tether is disposed upon the head. The tether is configured to engage with and alternately disengage from the second end. The lock pin is configured to engage each of the lock pin holes and the flag pole hole therethrough. Wherein, the lock pin is configured to reversibly secure the flag pole to the mount by threading each of the first lock pin hole, the flag pole hole, and the second lock pin hole, respectively. The tether is configured to secure the lock pin about the mount by engaging the second end. This configuration acts as a double safety. The first safety is the lock pin, which threads each of the first lock pin hole, the flag pole hole, and the second lock pin hole securing the flag pole to the mount. The second safety is the tether, which secures the lock pin through each of the first lock pin hole, the flag pole hole, and the second lock pin hole, tethering the lock pin about the mount.

The base is configured to conform to and engage with an extant truck bed stake pocket. Because there is no universal standard for truck bed stake pockets, the described device is configured to adopt a variety of dimensions that would enable the base to engage a variety of different sized truck bed stake pockets. It is also envisioned that the base and the mount can be composed of a single continuous molded or welded material, and alternately can be sectional or interchangeable without deviating from the scope and spirit of the invention.

Thus has been broadly outlined the more important features of the present truck bed stake pocket flag pole mount so that the detailed description thereof that follows may be better understood and in order that the present contribution to the art may be better appreciated.

Numerous objects, features and advantages of the present truck bed stake pocket flag pole mount will be readily apparent to those of ordinary skill in the art upon reading the following detailed description of presently preferred, but nonetheless illustrative, examples of the present truck bed stake pocket flag pole mount when taken in conjunction with the accompanying drawings.

### BRIEF DESCRIPTION OF THE DRAWINGS

### Figures

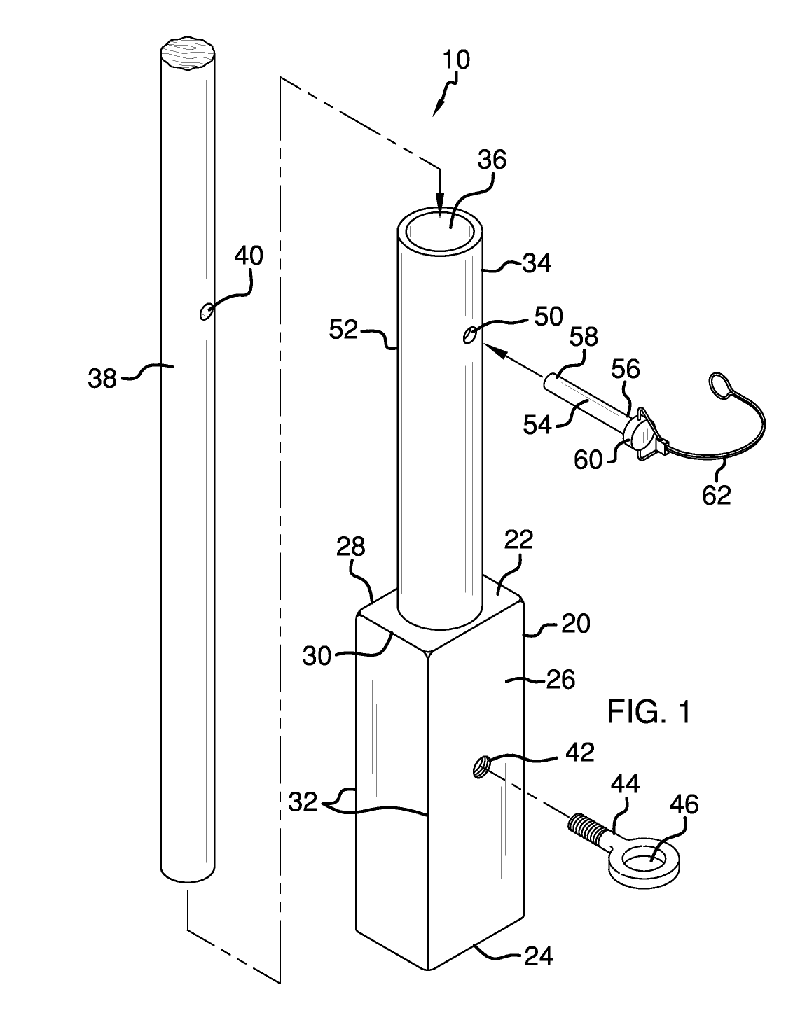

FIG. 1 is an isometric view.

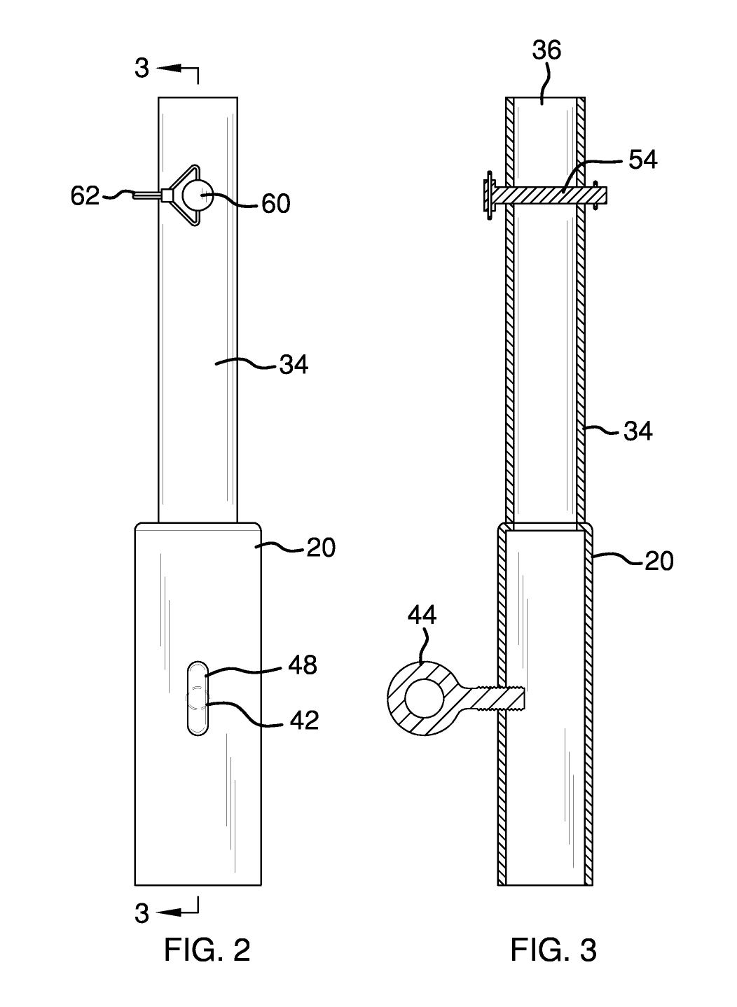

FIG. 2 is a frontal view.

FIG. 3 is a cross-sectional view.

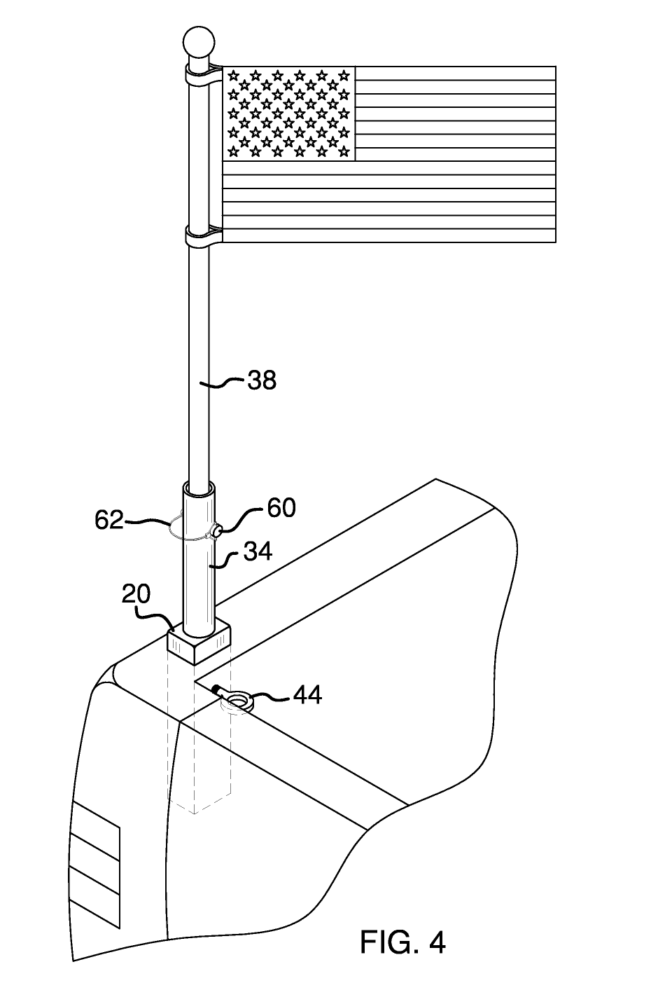

FIG. 4 is an in-use view.

### DETAILED DESCRIPTION OF THE DRAWINGS

With reference now to the drawings, and in particular FIGS. 1 through 4 thereof, the instant truck bed stake pocket flag pole mount employing the principles and concepts of the present truck bed stake pocket flag pole mount and generally designated by the reference number 10 will be described.

Referring to FIGS. 1 through 4 a preferred embodiment of the present truck bed stake pocket flag pole mount 10 is illustrated. The truck bed stake pocket flag pole mount 10 includes a parallelepiped base 20 having a first surface 22 spaced apart from a parallel second surface 24, and four spaced apart side surfaces 26 perpendicular to each of the first surface 22 and second surface 24. Each of the first surface 22 and second surface 24 have a pair of spaced apart parallel first edges 28 and a pair of spaced apart parallel second edges 30, respectively. Each of the second edges 30 are perpendicular to each of the first edges 28. The first edges 28 each have a length, while each of the second edges 30 have a width. Each of the side surfaces 26 define a total of four side edges 32 having a height.

A cylindrical mount 34 is medially disposed upon the first surface 22. The mount 34 has an elongated chamber 36 having a chamber diameter and a chamber length. The truck bed stake pocket flag pole mount 10 also includes a flag pole 38 having a flag pole hole 40. The flag pole 38 is configured to engage the elongated chamber 36 of the mount 34. The elongated chamber 36 is configured to conform to the flag pole 38 and support the flag pole 38 in a vertical or angular position. A person having skill in the art would appreciate that the mount 34 can be vertically disposed upon the first surface 22, and alternately can be disposed upon the first surface 22 at an angle.

A threaded aperture 42 is disposed upon one of the side surfaces 26 of the base 20. A threaded eyebolt 44 having an eye 46 is configured to frictionally engage the threaded aperture 42 through an extant eyelet 48 of an extant truck bed. The eyebolt 44 is configured to secure the base 20 to an extant truck bed stake pocket. The eyebolt 44 is also configured to secure an extant rope to the flag pole 38 serving as a safety to prevent the flag pole 38 from disengaging the elongated chamber 36.

A first lock pin hole 50 and a second lock pin hole 52 are diametrically disposed upon the mount 34. The truck bed stake pocket flag pole mount 10 also includes a lock pin 54 having a first end 56 and a second end 58. A head 60 is disposed upon the first end 56, and a tether 62 is disposed upon the head 60. The tether 62 is configured to engage with and alternately disengage from the second end 58. The lock pin 54 is configured to engage each of the lock pin holes 50, 52 and the flag pole hole 40 therethrough. Wherein, the lock pin 54 is configured to reversibly secure the flag pole 38 to the mount 34 by threading each of the first lock pin hole 50, the flag pole hole 40, and the second lock pin hole 52, respectively. The tether 62 is configured to secure the lock pin 54 about the mount 34 by engaging the second end 58. This configuration acts as a triple safety. The first safety is the lock pin 54, which threads each of the first lock pin hole 50, the flag pole hole 40, and the second lock pin hole 52 securing the flag pole 38 to the mount 34. The second safety is the tether 62, which secures the lock pin 54 through each of the first lock pin hole 50, the flag pole hole 40, and the second lock pin hole 52, tethering the lock pin 54 about the mount 34. The third safety is the rope that can be tied from the eye 46 of the eyebolt 44 to the flag pole 38.

The base 20 is configured to conform to and engage with an extant truck bed stake pocket. Because there is no universal standard for truck bed stake pockets, the described device is configured to adopt a variety of dimensions that would enable the base 20 to engage a variety of different sized truck bed stake pockets. It is also envisioned that the base 20 and the mount 34 can be composed of a single continuous molded or welded material, and alternately can be sectional or interchangeable without deviating from the scope and spirit of the invention.

What is claimed is:

1. A truck bed stake pocket flag pole mount comprising:
a parallelepiped base having a first surface spaced apart from a parallel second surface, and four spaced apart side surfaces perpendicular to each of the first surface and the second surface;
each of the first surface and the second surface have a pair of spaced apart parallel first edges and a pair of spaced apart parallel second edges, each of the second edges perpendicular to each of the first edges, each of the first edges having a length, each of the second edges having a width;
each of the side surfaces defining a quadruplicity of side edges, each of the side edges having a height;
a cylindrical mount medially disposed upon the first surface, the mount having an elongated chamber, the elongated chamber having a chamber diameter and a chamber length; and
a flag pole, the flag pole configured to engage the elongated chamber of the mount, the elongated chamber configured to conform to the flag pole;
wherein the base is configured to conform to and engage with an extant truck bed stake pocket.

2. The truck bed stake pocket flag pole mount of claim 1 further comprising:
a threaded aperture disposed upon one of the side surfaces; and
a threaded bolt configured to frictionally engage the threaded aperture through an extant eyelet of the extant truck bed, the threaded bolt configured to secure the base to the extant stake pocket of the extant truck bed.

3. The truck bed stake pocket flag pole mount of claim 2 further comprising:
a first lock pin hole and a second lock pin hole, each of the lock pin holes disposed upon the mount;
a flag pole hole disposed upon the flag pole;
a lock pin having a first end and a second end;
a head disposed upon the first end;
a tether disposed upon the head, the tether configured to engage with and alternately disengage from the second end;
the lock pin configured to engage each of the lock pin holes and the flag pole hole therethrough, wherein the lock pin is configured to reversibly secure the flag pole to the mount by threading each of the first lock pin hole, the flag pole hole, and the second lock pin hole respectively, the tether configured to secure the lock pin about the mount by engaging the second end.

4. The truck bed stake pocket flag pole mount of claim 3 wherein the threaded bolt is an eyebolt, the eyebolt having an eye, the eyebolt configured to secure an extant rope to the flag pole serving as a safety to prevent the flag pole from disengaging the elongated chamber.

5. The truck bed stake pocket flag pole mount of claim 4 wherein the mount is vertically disposed upon the first surface, the mount configured to vertically engage the flag pole.

6. The truck bed stake pocket flag pole mount of claim 4 wherein the mount is disposed upon the first surface at an angle, the mount configured to engage the flag pole at an angle.

7. The truck bed stake pocket flag pole mount of claim 4 wherein the length of the first edge is 2 inches, the width of the second edge is 1.5 inches, and the height of each of the side edges is 5.75 inches; and
wherein the chamber diameter is 1.25 inches and the chamber length is 6.75 inches.

8. The truck bed stake pocket flag pole mount of claim 5 wherein the base and the mount are composed of a single continuous molded or welded material.

9. The truck bed stake pocket flag pole mount of claim 5 wherein the base and the mount are composed of a single continuous molded or welded metal.

10. The truck bed stake pocket flag pole mount of claim 5 wherein the base and the mount are composed of a single continuous molded or welded polymer.

11. The truck bed stake pocket flag pole mount of claim 6 wherein the base and the mount are composed of a single continuous molded or welded material.

12. The truck bed stake pocket flag pole mount of claim 6 wherein the base and the mount are composed of a single continuous molded or welded metal.

13. The truck bed stake pocket flag pole mount of claim 6 wherein the base and the mount are composed of a single continuous molded or welded polymer.

14. A truck bed stake pocket flag pole mount comprising:
a parallelepiped base having a first surface spaced apart from a parallel second surface, and four spaced apart side surfaces perpendicular to each of the first surface and the second surface;
each of the first surface and the second surface have a pair of spaced apart parallel first edges and a pair of spaced apart parallel second edges, each of the second edges perpendicular to each of the first edges, each of the first edges having a length, each of the second edges having a width;
each of the side surfaces defining a quadruplicity of side edges, each of the side edges having a height;
a cylindrical mount medially disposed upon the first surface, the mount having an elongated chamber, the elongated chamber having a chamber diameter and a chamber length;
a flag pole, the flag pole configured to engage the elongated chamber of the mount, the elongated chamber configured to conform to the flag pole;
a threaded aperture disposed upon one of the side surfaces;
a threaded eyebolt having an eye, the eyebolt configured to frictionally engage the threaded aperture through an extant eyelet of an extant truck bed, the threaded eyebolt configured to secure the base to an extant truck bed stake pocket, the eyebolt configured to secure an extant rope to the flag pole serving as a safety to prevent the flag pole from disengaging the elongated chamber;
a first lock pin hole and a second lock pin hole, each of the lock pin holes disposed upon the mount;
a flag pole hole disposed upon the flag pole;
a lock pin having a first end and a second end;
a head disposed upon the first end;
a tether disposed upon the head, the tether configured to engage with and alternately disengage from the second end;
the lock pin configured to engage each of the lock pin holes and the flag pole hole therethrough, wherein the lock pin is configured to reversibly secure the flag pole to the mount by threading each of the first lock pin hole, the flag pole hole, and the second lock pin hole respectively, the tether configured to secure the lock pin about the mount by engaging the second end;
wherein the mount is vertically disposed upon the first surface, the mount configured to vertically engage the flag pole;
wherein the base is configured to conform to and engage with an extant truck bed stake pocket; and
wherein the base and the mount are composed of a continuous single continuous molded or welded material.
